(19) United States
(12) Patent Application Publication
(10) Pub. No.: US 2008/0048375 A1
(43) Pub. Date: Feb. 28, 2008

(54) Threaded-rod-driven, mechanically-actuated, portable, truss press

(75) Inventors: Roger Harold Rolfe, El Centro, CA (US); Melvin Leon Lamoreaux, El Centro, CA (US); Vincent Gerard Merten, Holtville, CA (US)

Correspondence Address: Roger H. Rolfe, P.O. Box 3412, El Centro, CA, 92244, US

(73) Assignee: Fortuss Builder's Supply Inc., El Centro, CA (US)

(21) Appl. No.: 11/510,209

(22) Filed: Aug. 24, 2006

(51) Int. Cl. B25B 1/10

(52) U.S. Cl. 269/249

(57) ABSTRACT

A threaded-rod-driven, mechanically-actuated, portable truss press for repairing truss joints has a c-clamp body with a yoke, and upper and lower arms. A drive rod travel housing with an internally-threaded opening is attached to the upper arm of the c-clamp body. A threaded drive rod with a drive nut attached to the upper end transverses the travel housing. An upper platen is attached to the lower end of the drive rod. A lower platen is attached to the lower arm of the c-clamp body. The drive rod is mechanically actuated using either a pneumatic, electric, or battery-powered impact wrench with a properly-sized socket attached. When the drive rod is actuated in a clock-wise direction the upper platen moves towards the lower platen with sufficient force to compress the teeth of metal connector plates into the wooden members of a truss joint placed between the platens.

### BACKGROUND

1. Field of Invention

This invention relates to devices for forming metal-plate-connected wood trusses, specifically to the repair of trusses outside of the normal manufacturing process, either at the construction site or in situ on a truss already installed.

2. Description of Prior Art

Pre-fabricated, metal-plate-connected, wood trusses have been used in the building industry for many years. These trusses are desirable because of their load-bearing capacity, relative light weight, and economic mass production. Truss assemblies typically are made of wooden top and bottom chords spaced apart according to building design. A plurality of wooden webs extends between the chords. The chords and webs are joined together by metal connector plates fabricated to have a multiplicity of teeth which are embedded into the wood members of the truss assembly so as to securely fasten all of the joints in the truss.

Truss assembly is generally affected using jigs configured to hold the members in place and the metal connector plates are then placed and pressed into the wood according to design specification. The pressing operation in the manufacturing facility is normally performed either by gantry-supported, hydraulically-actuated, c-frame presses or by large roller presses that pass over the assembly table. Once assembled, trusses are delivered to the building site and installed in the structure according to engineering specification.

In the process of moving, delivery, and installation, some truss webs and chords can be damaged to such an extent that the entire truss assembly looses its design integrity. The options for repairing a damaged truss are to either; repair the truss on site, repair the truss in situ if it is already installed, or to manufacture and deliver a replacement truss. On-site or in situ repair is the preferred method of correcting damage since it is significantly less time consuming and less expensive than fabricating a replacement truss or removing an installed truss and returning it to the manufacturing plant for repair. In order to repair a truss on-site or in situ, the damaged members and plates are removed and new, undamaged members are then placed into the truss assembly.

Originally, the replacement members were secured to the existing truss assembly using hand-nailed, plywood gussets. These gussets were difficult to install and it was difficult for engineers to make certain that the size and shape of the gusset, as well as the number and placement of the nails were adequate for the designed structure. The limitations of plywood gusset repairs were overcome with the introduction of hydraulically-actuated, portable presses for truss repair. The present industry practice for repairing trusses on site or in situ is to use a hydraulically-actuated, portable truss repair press. This press is basically a smaller version of the overhead-gantry presses commonly used in a truss manufacturing plant. Using a press allows repairs to be made on site or in situ using metal connector plates as originally specified by the truss designer and engineer.

Unfortunately, the hydraulically-actuated presses are cumbersome and awkward to use. In order to repair a truss that is already installed, an operator must take the hydraulic pump and motor with him into the frame structure of the building. The pump and motor are difficult to move because of their weight and bulk. The hydraulic lines that connect the pump to the c-frame press frequently interfere with the ability of the operator to properly position the device to press plates into the new repair elements and the already installed, undamaged portions of the truss assembly. Frequently two operators are required to complete the repair using this type of portable press. Additionally, hydraulic pumps and hoses are very susceptible to leaking. The cleanup of leaked hydraulic fluid adds labor cost to the project. Leaked fluid can also stain and damage other already installed building materials, such as gypsum board or carpeting, adding even more rework, callback, and repair cost.

### OBJECTS AND ADVANTAGES

Accordingly, besides the objects and advantages of allowing for on-site and in situ truss repair described in our patent above, several objects and advantages of the present invention are:
(a) to provide a portable truss repair press that is actuated without the need for a hydraulic pump and motor;
(b) to provide a portable truss repair press that has no hydraulic lines and hoses connected;
(c) to provide a portable truss repair press that does not have the potential to leak fluids that need to be cleaned up;
(d) to provide a portable truss repair press that does not have the potential to leak fluids that could cause damage to other building materials, and
(e) to provide a portable truss repair press that allows most repair operations to be performed by one operator.

### Still further objects and advantages will become apparent from a consideration of the ensuing description and drawings.

### SUMMARY

To achieve the foregoing and other objects and advantages and in accordance with the purpose of the present invention, as embodied and broadly described herein, a threaded-rod-driven, mechanically-actuated, portable truss press device includes:
(a) a c-frame body having a lower arm, a yoke with an integrated handle, and an upper arm;
(b) a drive rod travel housing containing an internally threaded opening attached to the front portion of the upper arm of the c-frame body;
(c) a threaded drive rod with a drive nut attached to the upper end which passes completely through the threaded opening inside the drive rod travel housing;
(d) an upper platen seated onto and attached to the lower end of the threaded drive rod so as to allow rotation about the threaded drive rod,
(e) a lower platen attached to the upper surface of the lower arm of the c-frame body, and
(f) a top handle attached to the center of the top of the c-frame body centered on and running parallel to the long axis of the upper arm.

In the preferred embodiment, the press is actuated using either; a pneumatic impact wrench attached to a properly-sized socket, an electric impact wrench attached to a properly-sized socket, or a battery-powered impact wrench attached to a properly-sized socket, which engages with and actuates the drive nut on the top of the threaded drive rod rotating the drive rod and moving the upper platen towards the lower platen with sufficient force to compress the teeth of a metal connector plate into lumber.

### DRAWINGS

### Drawing Figures

FIG. 1 shows a side view elevation of the invention;

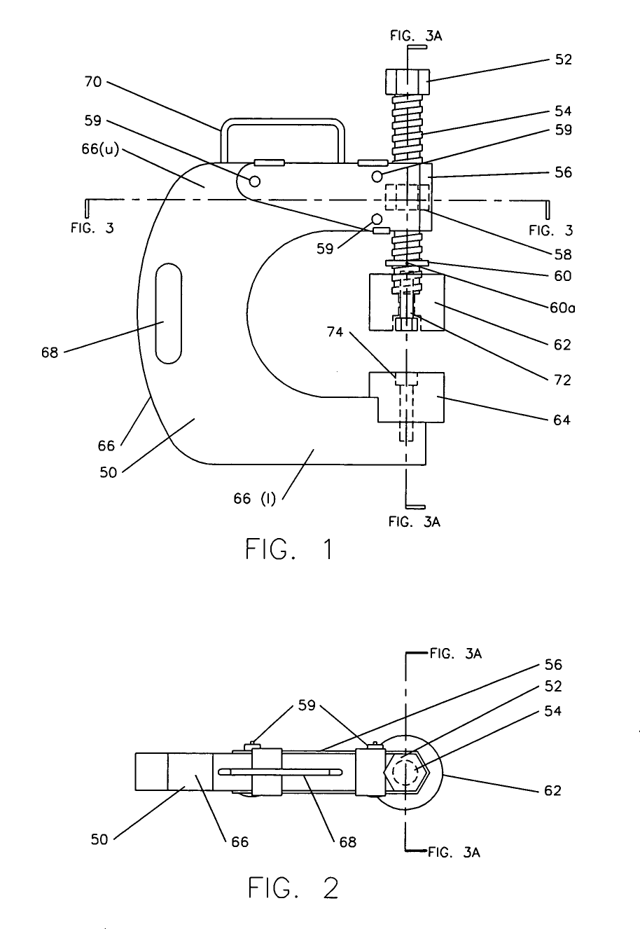

FIG. 2 shows a plan view of the invention;

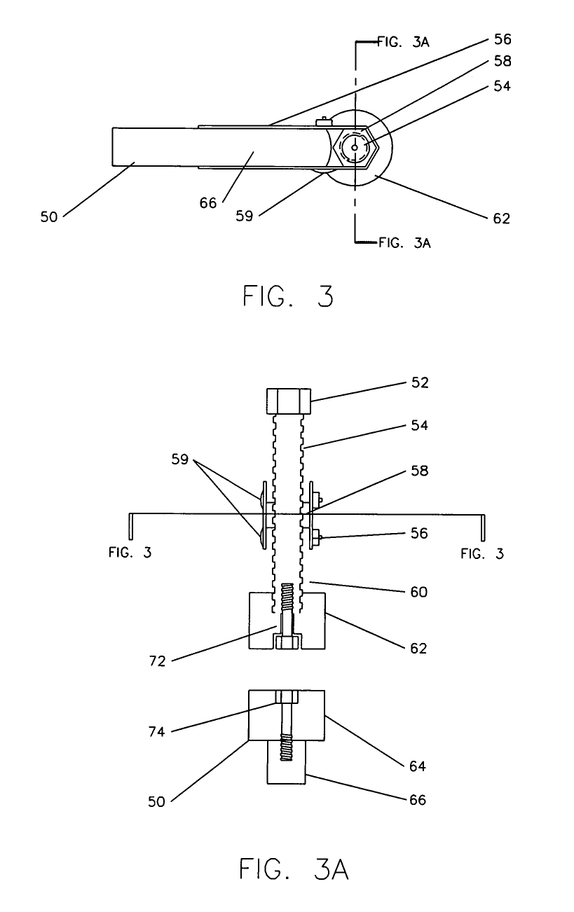

FIG. 3 shows a cross section of the view in FIG. 1 on line FIG. 3;

FIG. 3a shows a cross section of the view in FIG. 1 on line FIG. 3A;

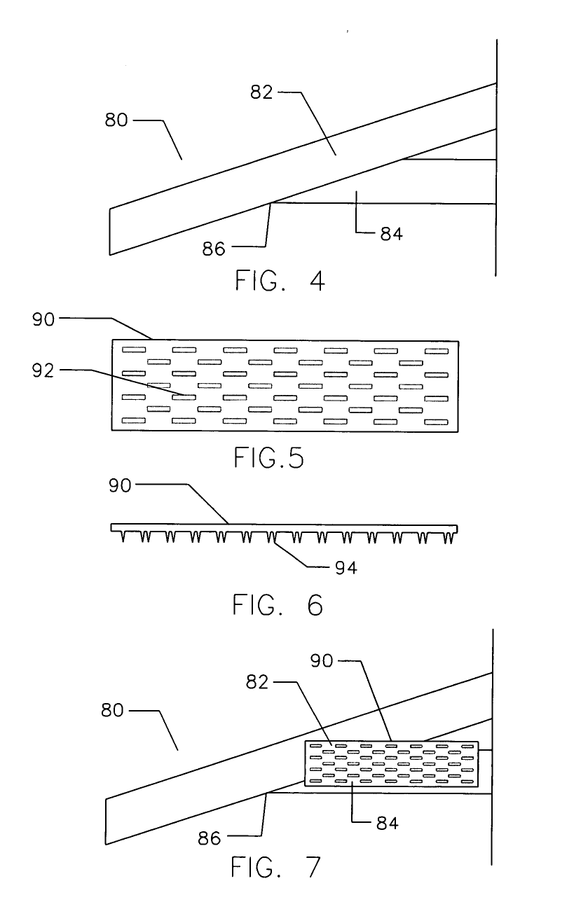

FIG. 4 shows plan view of a truss joint requiring connection;

FIG. 5 shows a top view of a metal connector plate typically used in truss joint construction;

FIG. 6 shows a side view of the metal connector plate illustrated in FIG. 5

FIG. 7 shows a top plan view of the truss joint illustrated in FIG. 4 having a metal connector plate secured thereto using the device constructed in accordance with the present invention.

### REFERENCE NUMERALS IN DRAWINGS

50 threaded-rod-driven, mechanically-actuated, portable truss press
52 drive nut
54 threaded drive rod
56 drive rod travel housing
58 drive rod travel nut
59 through bolts with nuts
60 retraction stop nut
60a set screw
62 upper platen
64 lower platen
66 c-clamp body
66u upper arm
66l lower arm
68 integrated handle
70 top handle
72 upper platen attachment bolt
74 lower platen attachment bolt
80 truss assembly section
82 truss top chord
84 truss bottom chord
86 truss joint
90 metal connector plate
92 rectangular holes
94 teeth

### DETAILED DESCRIPTION

### Preferred Embodiment

Referring to FIG. 1 and FIG. 2, a threaded-rod-driven, mechanically-actuated, portable truss press 50 is designed for repairing truss joints. The device 50 is relatively light-weight and portable and free of hydraulic hoses, pump, or motor. Use of the device 50 may take place on the ground at the job site, or in situ on a truss assembly already installed in the building structure. In the preferred embodiment, a c-clamp body 66 is provided. Said c-clamp body 66 comprises; a yoke with an integrated handle 68, an upper arm 66u, and a lower arm 66l. A drive rod travel housing 56 is removably attached to the upper arm 66u of said c-clamp body 66 by a multiplicity of through bolts with nuts 59. A drive rod travel nut 58 is fixedly attached to the inside of said drive rod travel housing 56 as shown in FIG. 3. A threaded drive rod 54 is threaded through said drive rod travel nut 58 so as to have one end extend away from the upper arm 66u of said c-clamp body 66 and the other end extend towards the lower arm 66l of said c-clamp body 66. A drive nut 52 is fixedly attached to the end of said threaded drive rod 54 that extends away from the upper arm 66u of said c-clamp body 66. A retraction stop nut 60 is threaded onto said threaded drive rod 54 on the end that extends toward the lower arm 66l of said c-clamp body 66. An upper platen 62, the upper surface of which has been bored in the diameter of the drive rod 54 to the depth of approximately 1 inch, is seated over and removably attached to the end of said threaded drive rod 54 that extends towards the lower arm 66l of said c-clamp body 66 using an upper platen attachment bolt 72 so as to allow said upper platen 62 to rotate on said upper platen attachment bolt 72. Said retraction stop nut 60 is fixed to said threaded drive rod 54 using a set screw 60a so as to be approximately 0.125 inches from said upper platen 62. A lower platen 64 is removably attached to the inner surface of the lower arm 66l of said c-clamp body 66 using a lower platen attachment bolt 74 so as to be fixed and positioned relatively opposite to said upper platen 62. A top handle 70 is fixedly attached to the center of the top of the upper arm 66u of said c-clamp body 66 centered on and running parallel to the long axis of the upper arm 66u of said c-clamp body 66.

### Operation

Referring now to FIG. 4, FIG. 5, FIG. 6, and FIG. 7, a truss assembly section 80 comprises a truss top chord 82 and a truss bottom chord 84. Said truss assembly section 80 is to be repaired at truss joint 86 which is formed by the junction of a truss top chord 82 and a truss bottom chord 84. Said truss top chord 82 and said truss bottom chord 84 are cut and laid out according to engineering specification. A metal connector plate 90 comprises a metal plate that has a multiplicity of rectangular holes 92 punched. The metal punched from said rectangular holes 92 remains attached to said metal connector plate 90 and is bent perpendicular to said metal connector plate 90 so as to form a multiplicity of teeth 94. Said metal connector plate 90, of dimension according to engineering specification, is placed according to engineering specification so as to overlap said truss joint 86 with said teeth 94 pointing into the wood of said truss top chord 82 and said truss bottom chord 84.

Referring to the device 50, said drive nut 52 is rotated in a counter-clockwise direction until said retraction stop nut 60 contacts the underside of the upper arm 66u of said c-clamp body 66. The device 50 is manipulated using the integrated handle 68 of said c-clamp body 66 and said top handle 70 so as to place some or all of said metal connector plate 90 and the portions of said truss top chord 82 and said truss bottom chord 84 that are under said metal connector plate 90 between said upper platen 62 and said lower platen 64 of the device 50. Said drive nut 52 is rotated in a clockwise direction. This rotation can be actuated using either; a pneumatic impact wrench with a properly-sized socket attached, an electric impact wrench with a properly-sized socket attached, or a battery-powered impact wrench with a properly-sized socket attached. This rotation causes said threaded drive rod 54 to pass through said drive rod travel nut 58 and move said upper platen 62 towards said lower platen 64 resulting in compression of said teeth 94 into the wood of said truss top chord 82 and said truss bottom chord 84. Rotation is continued until all of said teeth 94 under said upper platen 62 are completely embedded into the wood of said truss top chord 82 or said truss bottom chord 84. Said drive nut 52 is then rotated in a counter-clockwise direction until said retraction stop nut 60 again contacts the lower arm 66l of said c-clamp body 66. If the upper surface area of said metal connector plate 90 is larger than the flat, lower surface area of said upper platen 62, the operation is repeated over the sections of said metal connector plate 90 where said teeth 94 are not yet completely embedded into the wood of said truss top chord 82 or said truss bottom chord 84 until all of said teeth 94 that are in contact with the wood of said truss top chord 82 or said truss bottom chord 84 are completely embedded into the wood of said truss top chord 82 or said truss bottom chord 84.

### CONCLUSION

Thus the reader will see that the threaded-rod-driven, mechanically-actuated, portable truss press of the invention provides a relatively light-weight truss press that can be used to repair trusses at the construction site or in situ on truss assemblies already installed in the building structure. Because it is driven by a threaded rod and not connected by lines and hoses to a pump and motor it is relatively easy to manipulate and use and has no risk of causing fluid spills that need to be cleaned, or fluid spill damage to building materials.

While our above description contains many specificities, these should not be construed as limitations on the scope of the invention, but rather as an exemplification of one preferred embodiment thereof. Accordingly, the scope of the invention should be determined not by the embodiment illustrated, but by the appended claims and their legal equivalents.

We claim:

1. A threaded-rod-driven, mechanically-actuated, portable truss press device for repairing trusses by compressing the teeth of metal connector plates into the wood members of a truss joint to be repaired, comprising:
(a) a c-clamp body having an upper arm and a lower arm;
(b) a drive rod travel housing with an internally threaded opening for receiving a threaded drive rod;
(c) a threaded drive rod;
(d) a drive nut;
(e) an upper platen;
(f) a lower platen;
(g) said drive rod travel housing being attached to the upper arm of said c-clamp;
(h) said drive rod being threaded through the internally threaded opening of said travel housing so as to extend away from the upper arm of the c-clamp body at one end and into space between the upper and lower arms of the c-clamp body at the other end;
(i) said drive nut being attached to the end of the drive rod which extends away from the c-clamp body;
(j) said upper platen being seated onto and attached to the end of the drive rod which extends into the center of the c-clamp body so as to allow rotation around the attachment bolt;
(k) said lower platen being attached to the lower arm of said c-clamp body so as to be positioned generally opposed to said upper platen,
whereby by positioning the device with the platens on opposite sides of the truss joint to be repaired with the metal connector plates placed between the truss joint and the platens with the teeth of the metal connecter plate faced into the wood members of the truss joint, and then rotating the drive nut using either; a pneumatic impact wrench with a properly-sized socket attached, an electric impact wrench with a properly-sized socket attached, or a battery-powered impact wrench with a properly-sized socket attached, thus actuating said drive rod and causing said upper platen to move towards the lower platen, the teeth of the metal connector plate are compressed into the wood of the truss joint, effectuating a repair on the truss joint.

2. The device according to claim 1, wherein said c-clamp body is sized to allow a space between said upper platen and said lower platen sufficient to allow for the introduction of lumber and corresponding metal connector plates in 2×4 or 2×6 configuration typical in roof truss manufacture.

3. The device according to claim 1, wherein said c-clamp body is sized to allow a space between said upper platen and said lower platen sufficient to allow for the introduction of lumber and corresponding connector plates in 4×2 configurations typical in floor truss manufacture.

4. The device according to claim 1, wherein the upper platen and the lower platen are made of a hard, magnetic material that will hold the connector plate in position until the teeth can be compressed into the wood of the truss joint.

5. A method for repairing trusses, the method comprising: joining or splicing two pieces of lumber by compressing the teeth of metal connector plate into the two pieces of lumber by means of a threaded-rod-driven, mechanically-actuated, portable truss press device comprising:
(l) a c-clamp body having an upper arm, a yoke, and a lower arm;
(m) a drive rod travel housing defining an internally threaded opening for receiving a threaded drive rod;
(n) a threaded drive rod;
(o) a drive nut;
(p) an upper platen;
(q) a lower platen;
(r) said drive rod travel housing being attached to the upper arm of said c-clamp;
(s) said drive rod being threaded through the internally threaded opening of said travel housing so as to extend away from the upper arm of the c-clamp body at one end and into space between the upper and lower arms of the c-clamp body at the other end;
(t) said drive nut being attached to the end of the drive rod which extends away from the c-clamp body;
(u) said upper platen being seated onto and attached to the end of the drive rod which extends into the center of the c-clamp body so as to allow rotation around the attachment bolt;
(v) said lower platen being attached to the lower arm of said c-clamp body so as to be positioned generally opposed to said upper platen,
whereby by positioning the device with the platens on opposite sides of the truss joint to be repaired with the metal connector plates placed between the truss joint and the platens with the teeth of the metal connecter plate faced into the wood members of the truss joint, and then rotating the drive nut using either; a pneumatic impact wrench with a properly-sized socket attached, an electric impact wrench with a properly-sized socket attached, or a battery-powered impact wrench with a properly-sized socket attached, thus actuating said drive rod and causing said upper platen to move towards the lower platen, the teeth of the metal connector plate are compressed into the wood of the truss joint, effectuating a repair on the truss joint.

6. A method according to claim 5, wherein the repair operation of the truss joint is performed at the construction site where the truss to be repaired is to be used.

7. A method according to claim 5, wherein the repair operation of the truss joint is performed on a truss where at least one member of the truss assembly containing the truss joint to be repaired is installed in the building structure where it is to be employed before the repair operation is performed.
